(19) United States
(12) Patent Application Publication
(10) Pub. No.: US 2026/0277639 A1
(43) Pub. Date: Sep. 17, 2026

(54) SYSTEMS AND METHODS FOR DYNAMIC VEHICULAR MACHINE USER INTERFACE

(71) Applicant: Honda Motor Co., Ltd., Tokyo (JP)

(72) Inventor: Steven P. Turner, Marysville, OH (US)

(21) Appl. No.: 19/077,903

(22) Filed: Mar. 12, 2025

(51) Int. Cl. G06F 9/451

(52) U.S. Cl. CPC G06F 9/453

(57) ABSTRACT

A vehicle is provided. The vehicle includes a plurality of sensors including a first sensor and a second sensor. The vehicle also includes a vehicle controller. The vehicle controller is programmed to (i) identify a current driver of a vehicle based upon information from the plurality of sensors; (ii) access a driver profile for the current driver; (iii) determine a vehicle familiarity level of the current driver based upon the driver profile; and (iv) present one or more items on a user interface based upon the driver's vehicle familiarity level.

### FIELD OF THE INVENTION

The present disclosure relates to a dynamic machine user interface and, more particularly, to a system and method for controlling one or more user interfaces of a vehicle based upon the identity of the driver.

### BACKGROUND

Vehicles typically have some customizable settings. Some settings are linked to a key fob, some to a specific “memory” button in the car, or some are just last-user adjusted settings. However, current vehicles might not recognize or adapt when someone else drives the car who has different preferences. Similarly, many functions like ADAS (advanced driver assistance systems) are complicated so coaching applications are beneficial. However, if the coaching applications are shown to every user, every time they drive the vehicle, they become annoying, and there is an increased likelihood that the driver will ignore those applications and potentially other warning information. Suggestions made by the vehicle typically have no understanding of how many times this specific driver/user has gotten the suggestion or prompt. Accordingly, it would be desirable to have a system that assists drivers based on the driver and their experience with the vehicle and/or its systems.

### BRIEF SUMMARY

In one aspect, a vehicle is provided. The vehicle includes a plurality of sensors including a first sensor and a second sensor. The vehicle also includes a vehicle controller. The vehicle controller is programmed to identify a current driver of a vehicle based upon information from the plurality of sensors. The vehicle controller is also programmed to access a driver profile for the current driver. The vehicle controller is further programmed to determine a vehicle familiarity level of the current driver based upon the driver profile. In addition, the vehicle controller is programmed to present one or more items on a user interface based upon the driver's vehicle familiarity level. The vehicle may have additional, less, or alternate functionality, including that discussed elsewhere herein.

In another aspect, a computer device is provided. The computer device includes at least one memory and at least one processor in communication with the at least one memory. The at least one processor is programmed to identify a current driver of a vehicle based upon information from the plurality of sensors. The at least one processor is also programmed to access a driver profile for the current driver. The at least one processor is further programmed to determine a vehicle familiarity level of the current driver based upon the driver profile. In addition, the at least one processor is programmed to present one or more items on a user interface based upon the driver's vehicle familiarity level. The computer device may have additional, less, or alternate functionality, including that discussed elsewhere herein.

In still another aspect, a method for controlling a vehicle is provided. The method is implemented on a vehicle controller associated with the vehicle including at least one processor in communication with at least one memory. The method includes identifying a current driver of a vehicle based upon information from the plurality of sensors. The method also includes accessing a driver profile for the current driver. The method further includes determining a vehicle familiarity level of the current driver based upon the driver profile. In addition, the method includes presenting one or more items on a user interface based upon the driver's vehicle familiarity level. The method may have additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a schematic diagram of an exemplary vehicle, in accordance with one embodiment of the present disclosure.

FIG. 2 illustrates a flow chart of an exemplary computer-implemented process of adapting to driver familiarity of the vehicle shown in FIG. 1.

FIG. 3 illustrates a flow chart of another exemplary computer-implemented process of adapting to driver familiarity of the vehicle shown in FIG. 1.

FIG. 4 illustrates a simplified block diagram of an exemplary computer system for implementing the processes shown in FIGS. 2 & 3.

FIG. 5 illustrates an exemplary configuration of a user computer device, in accordance with one embodiment of the present disclosure.

FIG. 6 illustrates an exemplary configuration of a server computer device, in accordance with one embodiment of the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the term “database” may refer to either a body of data, a relational database management system (RDBMS), or to both, and may include a collection of data including hierarchical databases, relational databases, flat file databases, object-relational databases, object oriented databases, and/or another structured collection of records or data that is stored in a computer system.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random-access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable and include any computer program storage in memory for execution by personal computers, workstations, clients, servers, and respective processing elements thereof.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device, and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time for a computing device (e.g., a processor) to process the data, and the time of a system response to the events and the environment. In the embodiments described herein, these activities and events may be considered to occur substantially instantaneously.

The present embodiments may relate to, inter alia, systems and methods for dynamic machine user interface and, more particularly, to a system and method for controlling one or more user interfaces of a vehicle based upon the identity of the driver. In an exemplary embodiment, the process is performed by a vehicle controller computer device, also known as a vehicle controller.

The system described herein is configured to recognize vehicle drivers and provide smart suggestions to those drivers based on the past interactions of the driver with one or more vehicles. In the exemplary embodiment, a driver monitor camera in a vehicle applies facial recognition technology to identify a specific user and classify them as a new user, intermediate user, or experienced user. Based on the user's familiarity with certain features, the system provides relevant coaching or suggestions, including the option to purchase a new digital service that may be helpful based on their usage characteristics.

Vehicles typically have some customizable settings. Some settings are linked to a key fob, others are linked to a specific “memory” button in the vehicle, or still others are just last-user adjusted settings. Furthermore, some suggestions made by a vehicle have no understanding of how many times this specific driver/user has gotten the suggestion or prompt. With the system described herein and the new application of driver monitoring cameras, there is an opportunity to recognize a specific user and tailor their experience.

Furthermore, as the drivers are identified by facial recognition, the system is able to automatically apply settings customized to them. In some embodiments, this works even when using a specific vehicle the first time, such as borrowing a friend's vehicle or using a rental vehicle. A first example is having the driver's FM radio presets be loaded into their current vehicle when the driver has been identified. An additional benefit is to prevent the display of annoying warnings to a user who has frequently seen them before. Moreover, the system may also recognize that a driver has not dealt with a new feature, such as in a new vehicle, and be able to know to instruct the driver in the use of the new feature.

In the exemplary embodiment, the system recognizes and identifies a vehicle driver, such as via a driver monitor camera using facial recognition technology. The system categories the driver as a new user, an intermediate user, an experienced user, and/or other categories. In some embodiments, the driver is categorized as new, intermediate, or experienced based on their past experience with each feature of the vehicle. For example, a driver may be considered an experienced driver in regard to automatic cruise control, but a new driver with regards to a heads-up display. Based on the driver's familiarity with each feature, the system determines which smart suggestions to provide to the driver. The system provides relevant coaching or suggestions, including purchasing a new digital service that may be helpful based on their usage characteristics.

In the exemplary embodiment, the vehicle controller stores a driver profile for each driver that includes different settings and categories for those drivers. In some embodiments, the user/driver may store preferences that would let the vehicle controller know any other considerations for categorizing the driver. In some embodiments, the preferences are stored in the driver profile. In some embodiments, one or more servers store the driver profiles for a plurality of drivers. In other embodiments, one or more user devices of the driver store their corresponding driver profile and provide that profile to the vehicle controller.

In the exemplary embodiment, the vehicle controller is configured to recognize when a user situation is not optimized, and to recommend an ideal solution, such as through tooltips. The tooltips are configured to make the vehicle easier to use and to reduce complaints of usability or annoyance by making smart suggestions based on the user's experience level. Basic tooltips include, but are not limited to, how to store memory seat settings, how to pair phones or other user devices to the vehicle, and/or how to enable or use basic ADAS (advanced driver assistance systems) features. Intermediate tooltips include, but are not limited to, using driver history to offer intermediate user guidance to improve function usability, guided customize setting adjustment, setting up user preferences, and/or using advanced ADAS features or settings, for example.

At least one of the technical problems addressed by this system may include: (i) improving the accuracy of presentation of training information; (ii) reducing the likelihood of annoying pop-up reminders/warnings; (iii) customized driver experience; and (iv) reducing the chance of a driver ignoring reminders/warnings.

The methods and systems described herein may be implemented using computer programming or engineering techniques including computer software, firmware, hardware, or any combination or subset thereof, wherein the technical effects may be achieved by performing at least one of the following steps: a) identify a current driver of the vehicle based upon information from the plurality of sensors; b) access a driver profile for the current driver; c) determine a vehicle familiarity level of the current driver based upon the driver profile; d) present one or more items on a user interface based upon the driver's vehicle familiarity level; e) receive a plurality of sensor information from the plurality of sensors; f) monitor a plurality of actions of the current driver via the plurality of sensor information; g) update the driver profile for the current driver based upon the plurality of actions of the current driver; h) determine that the current driver is at a beginner level of the vehicle familiarity level for the vehicle; i) present the current driver with one or more beginner tool-tips about one or more features of the vehicle; j) determine that the current driver is at an intermediate level of the vehicle familiarity level for the vehicle; k) present the current driver with one or more intermediate tool-tips about one or more features of the vehicle; l) determine that the current driver is at an experienced level of the vehicle familiarity level for the vehicle; m) prevent the current driver from receiving the one or more tool-tips about one or more features of the vehicle; n) determine a feature experience level for the current driver for a first feature of the vehicle; o) determine whether or not to present a tool-tip for the first feature based upon the feature experience level of the current driver; p) determine whether or not to present a tool-tip for a first feature based upon whether or not the tool-tip for the first feature has been presented to the current driver; q) determine an app or subscription to present to the current driver based upon the driver profile of the current driver; r) determine the app or subscription to present to the current driver based upon one or more apps that the current driver owns; s) change one or more settings of the vehicle based upon the driver profile; t) store the driver profile in an external database; and/or u) retrieve the driver profile for the current driver from an external database.

### Exemplary Vehicle

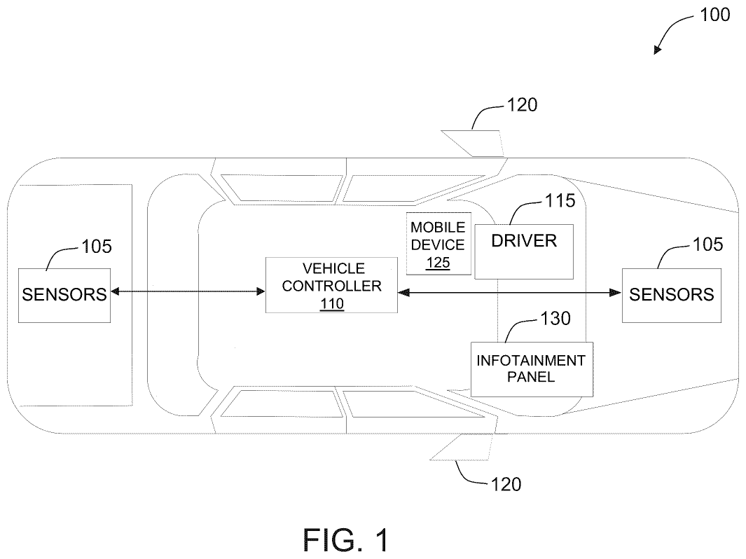

FIG. 1 depicts a view of an exemplary vehicle 100. In some embodiments, vehicle 100 may be an autonomous or semi-autonomous vehicle capable of fulfilling the transportation capabilities of a traditional automobile or other vehicle. In these embodiments, vehicle 100 may be capable of sensing its environment and navigating without human input. In other embodiments, vehicle 100 is a manual vehicle or a semi-autonomous vehicle with driver assistance systems, such as, but not limited to, lane keep assistance and parallel parking assistance, where the vehicle may be as a traditional automobile that is controlled by a driver 115.

Vehicle 100 may include a plurality of sensors 105 and a vehicle controller 110. The plurality of sensors 105 may detect the current surroundings and location of vehicle 100. Plurality of sensors 105 may include, but are not limited to, radar, LIDAR, proximity sensors, ultrasonic sensors, electromagnetic sensors, wide RADAR, long distance RADAR, Global Positioning System (GPS), video devices, imaging devices, cameras, audio recorders, and computer vision. Plurality of sensors 105 may also include sensors that detect conditions of vehicle 100, such as speed, acceleration, gear, braking, and other conditions related to the operation of vehicle 100, for example: at least one of a measurement of at least one of speed, direction rate of acceleration, rate of deceleration, location, position, orientation, and rotation of the vehicle, and a measurement of one or more changes to at least one of speed, direction rate of acceleration, rate of deceleration, location, position, orientation, and rotation of the vehicle. Furthermore, plurality of sensors 105 may include impact sensors that detect impacts to vehicle 100, including force and direction and sensors that detect actions of vehicle 100, such the deployment of airbags. In some embodiments, plurality of sensors 105 may detect the presence of driver 115 and one or more passengers (not shown) in vehicle 100. The plurality of sensors 105 may also be able to provide information to the vehicle controller 110 to allow the vehicle controller 110 to identify the driver 115. In some of these embodiments, the vehicle controller 110 stores a driver profile for one or more drivers and loads the corresponding driver profile when the driver 115 is identified. The driver profile may include information about the driver 115, including, but not limited to, seat settings, user interface settings, completed driver trainings, driver usage of different features of the vehicle 100, and/or any other information that is desired.

Vehicle controller 110 may interpret the sensory information to identify appropriate navigation paths, detect threats, and react to conditions. In some embodiments, vehicle controller 110 may be able to communicate with one or more remote computer devices, such as mobile device 125. In the example embodiment, mobile device 125 is associated with driver 115 and includes one or more internal sensors, such as an accelerometer, a gyroscope, and/or a compass. Mobile device 125 may be capable of communicating with vehicle controller 110 wirelessly. In addition, vehicle controller 110 and mobile device may be configured to communicate with computer devices located remotely from vehicle 100.

In some embodiments, vehicle 100 may include autonomous or semi-autonomous vehicle-related functionality or technology that may be used with the present embodiments to replace human driver actions may include and/or be related to the following types of functionality: (a) fully autonomous (driverless); (b) limited driver control; (c) vehicle-to-vehicle (V2V) wireless communication; (d) vehicle-to-infrastructure (and/or vice versa) wireless communication; (e) automatic or semi-automatic steering; (f) automatic or semi-automatic acceleration; (g) automatic or semi-automatic braking; (h) automatic or semi-automatic blind spot monitoring; (i) automatic or semi-automatic collision warning; (j) adaptive cruise control; (k) automatic or semi-automatic parking/parking assistance; (l) automatic or semi-automatic collision preparation (windows roll up, seat adjusts upright, brakes pre-charge, etc.); (m) driver acuity/alertness monitoring; (n) pedestrian detection; (o) autonomous or semi-autonomous backup systems; (p) road mapping systems; (q) software security and anti-hacking measures; (r) theft prevention/automatic return; (s) automatic or semi-automatic driving without occupants; and/or other functionality. In these embodiments, the autonomous or semi-autonomous vehicle-related functionality or technology may be controlled, operated, and/or in communication with vehicle controller 110.

The wireless communication-based autonomous or semi-autonomous vehicle technology or functionality may include and/or be related to: automatic or semi-automatic steering; automatic or semi-automatic acceleration and/or braking; automatic or semi-automatic blind spot monitoring; automatic or semi-automatic collision warning; adaptive cruise control; and/or automatic or semi-automatic parking assistance. Additionally or alternatively, the autonomous or semi-autonomous technology or functionality may include and/or be related to: driver alertness or responsive monitoring; pedestrian detection; artificial intelligence and/or back-up systems; hazard avoidance; navigation or GPS-related systems; security and/or anti-hacking measures; and/or theft prevention systems.

While vehicle 100 may be an automobile in the exemplary embodiment, in other embodiments, vehicle 100 may be, but is not limited to, other types of ground craft, aircraft, watercraft, and spacecraft vehicles.

### Exemplary Computer Process

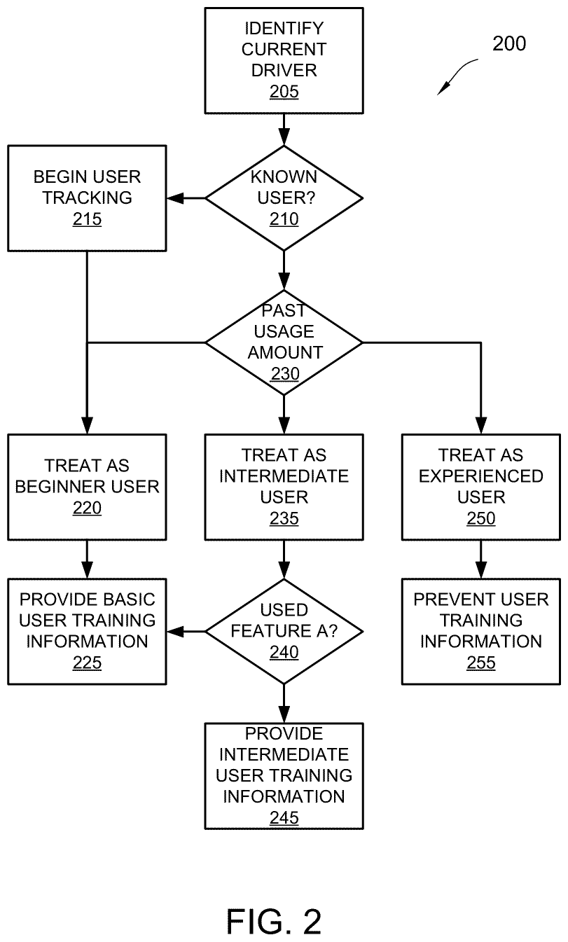

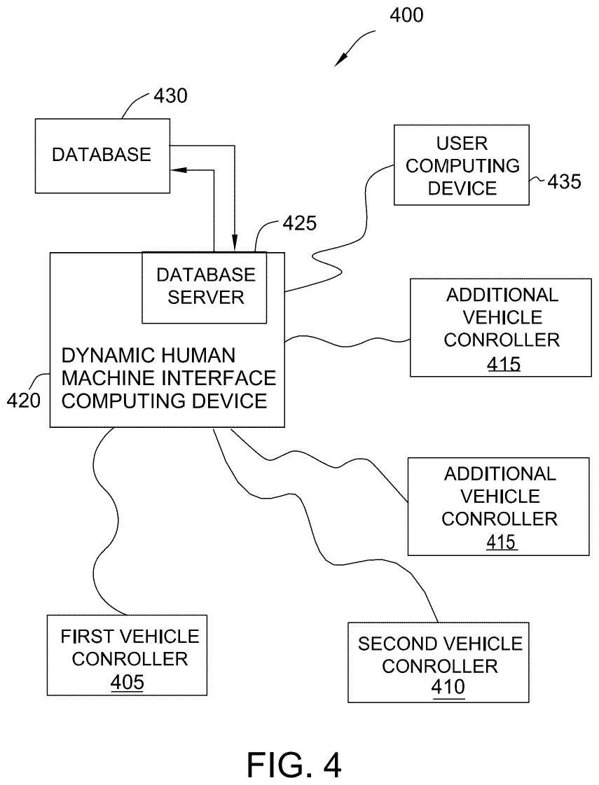

FIG. 2 illustrates a flow chart of an exemplary computer-implemented process 200 of adapting to driver familiarity of the vehicle 100 (shown in FIG. 1). In some embodiments, process 200 is performed by the vehicle controller 110 (shown in FIG. 1). In other embodiments, one or more steps of process 200 are performed by the dynamic human machine interface (DHMI) computing device 420 (shown in FIG. 4). Process 200 determines which features to provide training information to the user based upon the user's familiarity with the vehicle 100.

In the exemplary embodiment, database 430 (shown in FIG. 4) stores a plurality of driver profiles for a plurality of drivers. The plurality of driver profiles each store a plurality of information about the corresponding driver. This information may include, but is not limited to, radio preferences, entertainment preferences, seat settings, mirror settings, vehicle makes and models driven, vehicle features used, how different vehicle features were used, driver response to different warnings, notifications, tool tips, etc.

In the exemplary embodiment, the vehicle controller 110 identifies 205 the current driver 115 of the vehicle 100 (both shown in FIG. 1). In the exemplary embodiment, a driver monitor camera captures one or more images of the current driver 115. The vehicle controller 110 identifies 205 the driver 115 from the one or more images. In some embodiments, the vehicle controller 110 uses a local database 430 of driver images to identify 205 the driver. In other embodiments, the vehicle controller 110 access external servers, such as DHMI server 420, to identify 205 the driver 115. This may include transmitting the one or more images to the DHMI server 420 and receiving the driver identification. In these embodiments, the DHMI server 420 return the driver profile to the vehicle controller 110. In still further embodiments, the vehicle controller 110 also uses information from a key fob or other vehicle activation device to confirm the identity of the driver 115.

In the exemplary embodiment, the vehicle controller 110 determines 210 if the driver 115 is a known user. If the driver 115 does not have a driver profile, aka is not a known user, the vehicle controller 110 begins 215 tracking the user. Since the vehicle controller 110 does not a have a profile for the driver 115, the vehicle controller 110 treats 220 the driver 115 as a beginner user. The vehicle controller 110 provides 225 basic user training information to the driver 115. This includes, but it not limited to, providing the driver 115 with tooltips about different vehicle features and their functionality, prioritizing the owner's manual icon on one or more infotainment menus, provide warnings, pop-ups, and notifications as needed, recommend how to use different features of the vehicle 100.

In the exemplary embodiment, the vehicle controller 110 determines 230 a past usage amount for the driver 115. This is based on the information in the driver profile and how much the driver 115 may have used this vehicle 100, other vehicles of the same type, and other vehicles that had similar features. If the driver 115 has less than a first threshold worth of experience, the vehicle controller 110 determines 230 to treat 220 the driver 115 as a beginning user. This threshold may be where the driver 115 has used the vehicle 100 and corresponding features less than a specific number of operating hours. The threshold may also be where the driver 115 has only interacted with a first number of vehicle features.

If the driver 115 has more experience than the first threshold, but less than a second threshold of experience, the vehicle controller 110 determines 230 to treat 235 the driver 115 as an intermediate user. The intermediate user could be considered one where the driver 115 has interacted with some of the features of the vehicle. For each feature, the vehicle controller 110 determines 240 if the driver 115 has used the corresponding feature in the past based upon the information in their driver profile. If the driver 115 has not used the corresponding feature, then the vehicle controller 110 provides 225 basic user training information for that feature. If the driver 115 has used the corresponding feature, then the vehicle controller 110 provides 245 intermediate user training information, such as intermediate level tooltips. In some embodiments, the vehicle controller 110 determines 240 that the driver 115 has used a feature only after the driver 115 has used that feature a specific number of times.

If the driver 115 has more experience than the second threshold, the vehicle controller 110 treats 250 the driver as an experienced user. The vehicle controller 110 prevents user training information from automatically appearing for the driver 115. The vehicle controller 110 still allows the driver 115 to request and look-up information; however, the vehicle controller 110 does not push training information to the driver 115.

In some embodiments, the vehicle controller 110 is in communication with one or more service provider servers that are external to the vehicle 100. The vehicle controller 110 may present information about subscriptions and/or application that the driver 115 may acquire, either through purchasing and/or downloads, to add one or more features to the vehicle 100.

In the exemplary embodiment, the vehicle controller 110 is configured to recognize when a user situation is not optimized, and to recommend an ideal solution, such as through tooltips. The tooltips are configured to make the vehicle 100 easier to use and to reduce complaints of usability or annoyance by making smart suggestions based on the user's experience level. Basic tooltips include, but are not limited to, how to store memory seat settings, how to pair phones or other user devices to the vehicle 100, and/or how to enable or use basic ADAS features. Intermediate tooltips include, but are not limited to, using driver history to offer intermediate user guidance to improve function usability, guided customize setting adjustment, setting up user preferences, and/or using advanced ADAS features or settings, for example.

### Exemplary Computer Process

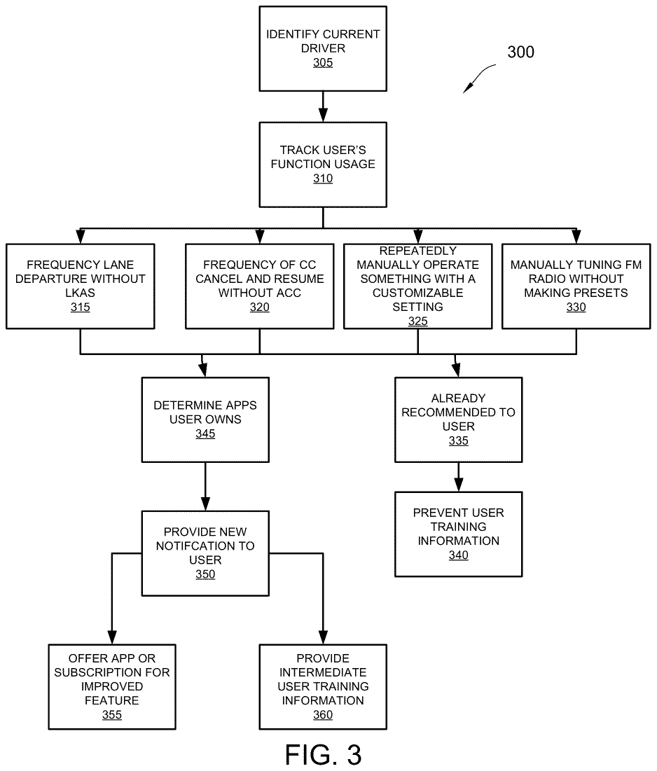

FIG. 3 illustrates a flow chart of an exemplary computer-implemented process 300 of tracking user of different features of the vehicle 100 (shown in FIG. 1). In some embodiments, process 300 is performed by the vehicle controller 110 (shown in FIG. 1). In other embodiments, one or more steps of process 200 are performed by the dynamic human machine interface (DHMI) computing device 420 (shown in FIG. 4). Process 300 determines which features to provide training information to the user based upon the user's familiarity with the vehicle 100.

In the exemplary embodiment, database 430 (shown in FIG. 4) stores a plurality of driver profiles for a plurality of drivers. The plurality of driver profiles each store a plurality of information about the corresponding driver. This information may include, but is not limited to, radio preferences, entertainment preferences, seat settings, mirror settings, vehicle makes and models driven, vehicle features used, how different vehicle features were used, driver response to different warnings, notifications, tool tips, etc.

In the exemplary embodiment, the vehicle controller 110 identifies 305 the current driver 115 of the vehicle 100 (both shown in FIG. 1). In the exemplary embodiment, a driver monitor camera captures one or more images of the current driver 115. The vehicle controller 110 identifies 305 the driver 115 from the one or more images. In some embodiments, the vehicle controller 110 uses a local database 430 of driver images to identify 305 the driver. In other embodiments, the vehicle controller 110 access external servers, such as DHMI server 420, to identify 305 the driver 115. This may include transmitting the one or more images to the DHMI server 420 and receiving the driver identification. In these embodiments, the DHMI server 420 return the driver profile to the vehicle controller 110.

In the exemplary embodiment, the vehicle controller 110 tracks 310 the user's function usage. In some embodiments, the vehicle controller 110 tracks 310 how often and how each user/driver 115 uses the different functions and features of the vehicle 100. Examples include, but are not limited to, the frequency of lane departure without using the lane keeping assist system (LKAS) 315, the frequency of cruise control cancel and resume without automatic cruise control 320, repeatedly manually operating a feature with a customizable setting 325, manually tuning FM radio without making presets 330, and/or any other desired or ignored setting. In the exemplary embodiment, the vehicle controller 110 receives sensor information from the plurality of sensors 105 and uses the sensor information to determine the actions of the driver 115 of the vehicle 100.

In the exemplary embodiment, the vehicle controller 110 determines 345 which apps the user owns. This includes applications, subscription services, vehicle software enhancements, and/or any other optional software that executes on the vehicle 100. The vehicle controller 110 uses the user's apps and the user's driving behaviors 315, 320, 325, and 330 to determine if there are any suggestions to provide to the user. If there are any suggestions, then the vehicle controller 110 provides 350 a new notification to the user. The notification may include an offer app or subscription 355 for an improved feature. The notification may also provide 360 intermediate user training information to train the user on one or more features of the vehicle 100. If one or more items have already been recommended 335 to the user, then the vehicle controller 110 prevents 340 any user training information from appearing to the user.

### Exemplary Computer System

FIG. 4 illustrates a simplified block diagram of an exemplary computer system 400 for implementing the processes 200 and 300 (shown in FIGS. 2 & 3). In the exemplary embodiment, computer system 400 may be used for providing a dynamic user interface on the vehicles 100 (shown in FIG. 1). As described below in more detail, a dynamic human machine interface (DHMI) server 420 (also known as a dynamic human machine interface (DHMI) computer device 420) may be configured to identify a current driver 115 of a vehicle 100 based upon information from the plurality of sensors 105; (ii) access a driver profile for the current driver 115; (iii) determine a vehicle familiarity level of the current driver 115 based upon the driver profile; and (iv) present one or more items on a user interface based upon the driver's vehicle familiarity level.

In the exemplary embodiment, first vehicle controller 405, second vehicle controller 410, and additional vehicle controllers 415 are computers that control one or more aspects of the operation of a vehicle 100 and are similar to vehicle controller 110 (both shown in FIG. 1). Furthermore, first vehicle controller 405, second vehicle controller 410, and additional vehicle controllers 415 are in communication with the dynamic human machine interface (DHMI) computing device 420, using the Internet or other network. More specifically, first vehicle controller 405, second vehicle controller 410, and additional vehicle controllers 415 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. In at least one embodiment, the first vehicle controller 405, the second vehicle controller 410, and the additional vehicle controllers 415 are all in communication with the DHMI computing device 420 to receive and store driver profiles. This allows the same driver profile to be used in different vehicles 100.

A database server 425 may be communicatively coupled to a database 430 that stores data. In one embodiment, database 430 may include driver profiles and driver identification information. In the exemplary embodiment, database 430 may be stored remotely from DHMI computing device 420. In some embodiments, database 430 may be decentralized. In the exemplary embodiment, the user may access database 430 via user computing device 435 by logging onto DHMI computing device 420, as described herein.

In the exemplary embodiment, user computer devices 435 are computers that include a web browser or a software application, which enables user computer devices 435 to access remote computer devices, such as DHMI computing device 420, using the Internet or other network. More specifically, user computer devices 435 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. User computer devices 435 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

DHMI computing device 420 (also known as DHMI server 420) may be communicatively coupled with one or more of first vehicle controller 405, second vehicle controller 410, and additional vehicle controllers 415. In some embodiments, DHMI computing device 420 may be associated with, or is part of a computer network associated with a vehicle manufacturer, or in communication with vehicle manufacturing network or travel information provider network. In other embodiments, DHMI computing device 420 may be associated with a third party and is merely in communication with the vehicle manufacturing networks. More specifically, DHMI computing device 420 is communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. DHMI computing device 420 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In the exemplary embodiment, DHMI computing device 420 hosts an application or website that allows the first vehicle controller 405, second vehicle controller 410, and additional vehicle controllers 415 to access the functionality described herein. In some further embodiments, first vehicle controller 405, second vehicle controller 410, and additional vehicle controllers 415 include an application that facilitates communication with DHMI computing device 420.

### Exemplary Client Device

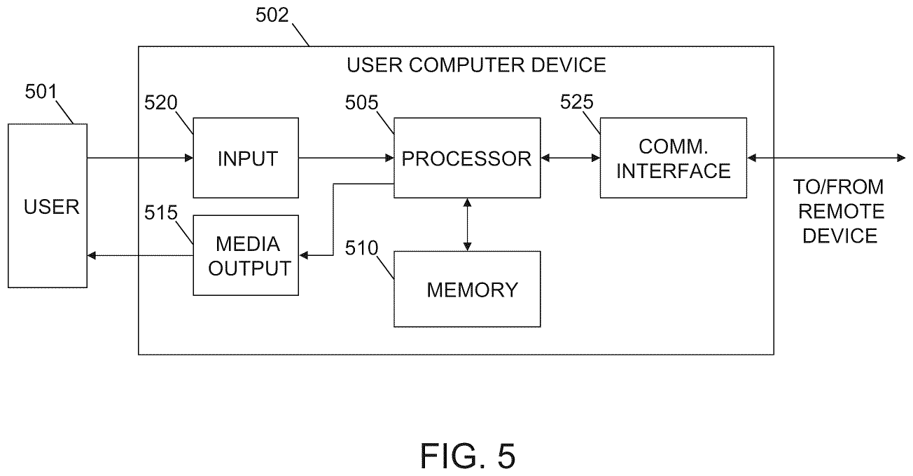

FIG. 5 depicts an exemplary configuration of the computer devices shown in FIGS. 1 & 4, in accordance with one embodiment of the present disclosure. User computer device 502 may be operated by a user 501. In the exemplary embodiment, user 501 may be similar to driver 115 (shown in FIG. 1). User computer device 502 may include, but is not limited to, vehicle controller 110, mobile device 125 (both shown in FIG. 1), DHMI computing device 420, first vehicle controller 405, second vehicle controller 410, additional vehicle controller 415, and user computing device 435 (all shown in FIG. 4). User computer device 502 may include a processor 505 for executing instructions. In some embodiments, executable instructions are stored in a memory area 510. Processor 505 may include one or more processing units (e.g., in a multi-core configuration). Memory area 510 may be any device allowing information such as executable instructions and/or transaction data to be stored and retrieved. Memory area 510 may include one or more computer readable media.

User computer device 502 may also include at least one media output component 515 for presenting information to user 501. Media output component 515 may be any component capable of conveying information to user 501. In some embodiments, media output component 515 may include an output adapter (not shown) such as a video adapter and/or an audio adapter. An output adapter may be operatively coupled to processor 505 and operatively coupleable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 515 may be configured to present a graphical user interface (e.g., a web browser and/or a client application) to user 501, such as through the infotainment panel 130 (shown in FIG. 1). A graphical user interface may include, for example, an interactive display and information about the operation of the vehicle 100 (shown in FIG. 1). In some embodiments, user computer device 502 may include an input device 520 for receiving input from user 501. User 501 may use input device 520 to, without limitation, select and/or enter one or more items to update.

Input device 520 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 515 and input device 520.

User computer device 502 may also include a communication interface 525, communicatively coupled to a remote device such as mobile device 125 or vehicle controller 110. Communication interface 525 may include, for example, a wired or wireless network adapter and/or a wireless data transceiver for use with a mobile telecommunications network.

Stored in memory area 510 are, for example, computer readable instructions for providing a user interface to user 501 via media output component 515 and, optionally, receiving and processing input from input device 520. A user interface may include, among other possibilities, a web browser and/or a client application. Web browsers enable users, such as user 501, to display and interact with media and other information typically embedded on a web page or a website from vehicle controller 110. A client application allows user 501 to interact with, for example, vehicle controller 110. For example, instructions may be stored by a cloud service, and the output of the execution of the instructions sent to the media output component 515.

Processor 505 executes computer-executable instructions for implementing aspects of the disclosure. In some embodiments, the processor 505 is transformed into a special purpose microprocessor by executing computer-executable instructions or by otherwise being programmed. For example, the processor 505 may be programmed with the instruction such as illustrated in FIGS. 2 & 3.

In some embodiments, user computer device 502 may include, or be in communication with, one or more sensors, such as sensor 105 (shown in FIG. 1). User computer device 502 may be configured to receive data from the one or more sensors and store the received data in memory area 510. Furthermore, user computer device 502 may be configured to transmit the sensor data to a remote computer device, such as vehicle controller 110 or mobile device 125, through communication interface 525.

The types of autonomous or semi-autonomous vehicle-related functionality or technology that may be used with the present embodiments to replace human driver actions may include and/or be related to the following types of functionality: (a) fully autonomous (driverless); (b) limited driver control; (c) vehicle-to-vehicle (V2V) wireless communication; (d) vehicle-to-infrastructure (and/or vice versa) wireless communication; (e) automatic or semi-automatic steering; (f) automatic or semi-automatic acceleration; (g) automatic or semi-automatic braking; (h) automatic or semi-automatic blind spot monitoring; (i) automatic or semi-automatic collision warning; (j) adaptive cruise control; (k) automatic or semi-automatic parking/parking assistance; (l) automatic or semi-automatic collision preparation (windows roll up, seat adjusts upright, brakes pre-charge, etc.); (m) driver acuity/alertness monitoring; (n) pedestrian detection; (o) autonomous or semi-autonomous backup systems; (p) road mapping systems; (q) software security and anti-hacking measures; (r) theft prevention/automatic return; (s) automatic or semi-automatic driving without occupants; and/or other functionality.

### Exemplary Server Device

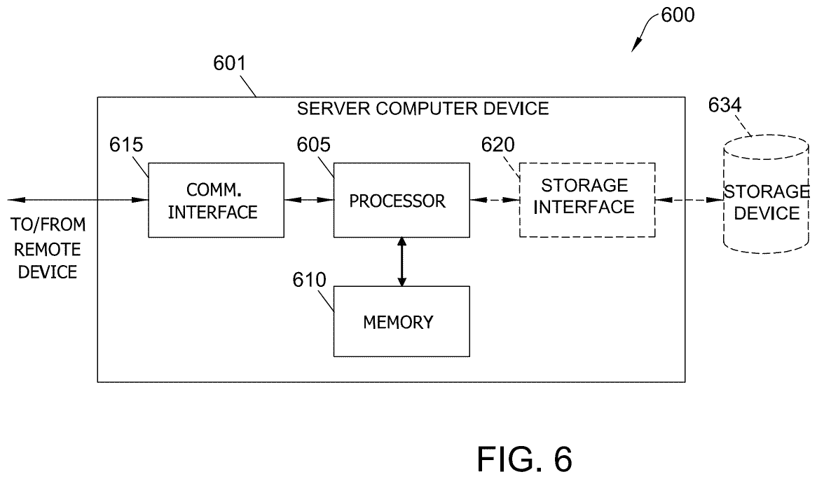

FIG. 6 depicts an exemplary configuration 600 of a server computer device 601, in accordance with one embodiment of the present disclosure. In the exemplary embodiment, server computer device 601 may be similar to, or the same as, dynamic human machine interface (DHMI) computing device 420 (shown in FIG. 4). Server computer device 601 may include, but is not limited to, DHMI computing device 420 and database server 425 (shown in FIG. 4). Server computer device 601 may also include a processor 605 for executing instructions. Instructions may be stored in a memory area 610. Processor 605 may include one or more processing units (e.g., in a multi-core configuration).

Processor 605 may be operatively coupled to a communication interface 615 such that server computer device 601 is capable of communicating with a remote device such as another server computer device 601, DHMI computing device 420, first vehicle controller 405, second vehicle controller 410 (both shown in FIG. 4), additional vehicle controllers 415, and user computer devices 435 (both shown in FIG. 4) (for example, using wireless communication or data transmission over one or more radio links or digital communication channels). For example, communication interface 615 may receive requests from user computer devices 435 via the Internet, as illustrated in FIG. 4.

Processor 605 may also be operatively coupled to a storage device 634. Storage device 634 may be any computer-operated hardware suitable for storing and/or retrieving data, such as, but not limited to, data associated with database 430 (shown in FIG. 4). In some embodiments, storage device 634 may be integrated in server computer device 601. For example, server computer device 601 may include one or more hard disk drives as storage device 634.

In other embodiments, storage device 634 may be external to server computer device 601 and may be accessed by a plurality of server computer devices 601. For example, storage device 634 may include a storage area network (SAN), a network attached storage (NAS) system, and/or multiple storage units such as hard disks and/or solid-state disks in a redundant array of inexpensive disks (RAID) configuration.

In some embodiments, processor 605 may be operatively coupled to storage device 634 via a storage interface 620. Storage interface 620 may be any component capable of providing processor 605 with access to storage device 634. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 634.

Processor 605 may execute computer-executable instructions for implementing aspects of the disclosure. In some embodiments, the processor 605 may be transformed into a special purpose microprocessor by executing computer-executable instructions or by otherwise being programmed. For example, the processor 605 may be programmed with the instruction such as illustrated in FIGS. 2 & 3.

In the exemplary embodiment, a vehicle 100 includes a plurality of sensors 105 and a vehicle controller 110 (all shown in FIG. 1). The vehicle controller is programmed to identify a current driver 115 (shown in FIG. 1) of the vehicle 100 based upon information from the plurality of sensors 105.

The vehicle controller 110 is also programmed to access a driver profile for the current driver 115. The vehicle controller 110 is further programmed to determine a vehicle familiarity level of the current driver 115 based upon the driver profile. In addition, the vehicle controller 110 is programmed to present one or more items on a user interface based upon the driver's vehicle familiarity level.

In some embodiments, the vehicle controller 110 is further programmed to receive a plurality of sensor information from the plurality of sensors. The vehicle controller 110 is also programmed to monitor a plurality of actions of the current driver 115 via the plurality of sensor information. The vehicle controller 110 is programmed to update the driver profile for the current driver 115 based upon the plurality of actions of the current driver 115.

In some further embodiments, the vehicle controller 110 is further programmed to determine that the current driver 115 is at a beginner level of the vehicle familiarity level for the vehicle 100. The vehicle controller 110 is also programmed to present the current driver 115 with one or more beginner tooltips about one or more features of the vehicle 100.

In some further embodiments, the vehicle controller 110 is further programmed to determine that the current driver 115 is at an intermediate level of the vehicle familiarity level for the vehicle 100. The vehicle controller 110 is also programmed to present the current driver 115 with one or more intermediate tooltips about one or more features of the vehicle 100.

In some further embodiments, the vehicle controller 110 is further programmed to determine that the current driver 115 is at an experienced level of the vehicle familiarity level for the vehicle 100. The vehicle controller 110 is also programmed to prevent the current driver from receiving one or more tooltips about one or more features of the vehicle.

In some further embodiments, the vehicle controller 110 is further programmed to determine a feature experience level for the current driver 115 for a first feature of the vehicle 100. The vehicle controller 110 is also programmed to determine whether or not to present a tooltip for the first feature based upon the feature experience level of the current driver 115.

In some further embodiments, the vehicle controller 110 is further programmed to determine whether or not to present a tooltip for a first feature based upon whether or not the tooltip for the first feature has been presented to the current driver 115.

In some further embodiments, the vehicle controller 110 is further programmed to determine an app or subscription to present to the current driver 115 based upon the driver profile of the current driver 115. The vehicle controller 110 is also programmed to determine the app or subscription to present to the current driver 115 based upon one or more apps that the current driver 115 owns.

In some further embodiments, the vehicle controller 110 is further programmed to change one or more settings of the vehicle 100 based upon the driver profile.

In some further embodiments, the vehicle controller 110 is further programmed to store the driver profile in an external database 430 (shown in FIG. 4).

In some further embodiments, the vehicle controller 110 is further programmed to retrieve the driver profile for the current driver 115 from an external database 430.

For the methods discussed directly above, the wireless communication-based autonomous or semi-autonomous vehicle technology or functionality may include and/or be related to: automatic or semi-automatic steering; automatic or semi-automatic acceleration and/or braking; automatic or semi-automatic blind spot monitoring; automatic or semi-automatic collision warning; adaptive cruise control; and/or automatic or semi-automatic parking assistance. Additionally or alternatively, the autonomous or semi-autonomous technology or functionality may include and/or be related to: driver alertness or responsive monitoring; pedestrian detection; artificial intelligence and/or back-up systems; navigation or GPS-related systems; security and/or anti-hacking measures; and/or theft prevention systems.

The computer-implemented methods and processes described herein may include additional, fewer, or alternate actions, including those discussed elsewhere herein. The present systems and methods may be implemented using one or more local or remote processors, transceivers, and/or sensors (such as processors, transceivers, and/or sensors mounted on vehicles, stations, nodes, or mobile devices, or associated with smart infrastructures and/or remote servers), and/or through implementation of computer-executable instructions stored on non-transitory computer-readable media or medium. Unless described herein to the contrary, the various steps of the several processes may be performed in a different order, or simultaneously in some instances.

Additionally, the computer systems discussed herein may include additional, fewer, or alternative elements and respective functionalities, including those discussed elsewhere herein, which themselves may include or be implemented according to computer-executable instructions stored on non-transitory computer-readable media or medium.

In the exemplary embodiment, a processing element may be instructed to execute one or more of the processes and subprocesses described above by providing the processing element with computer-executable instructions to perform such steps/sub-steps, and store collected data (e.g., vehicle profiles, etc.) in a memory or storage associated therewith. This stored information may be used by the respective processing elements to make the determinations necessary to perform other relevant processing steps, as described above.

The aspects described herein may be implemented as part of one or more computer components, such as a client device, system, and/or components thereof, for example. Furthermore, one or more of the aspects described herein may be implemented as part of a computer network architecture and/or a cognitive computing architecture that facilitates communications between various other devices and/or components. Thus, the aspects described herein address and solve issues of a technical nature that are necessarily rooted in computer technology.

The exemplary systems and methods described and illustrated herein therefore significantly increase the safety of operation of autonomous and semi-autonomous vehicles by improving the dynamic machine user interface and, more particularly, to controlling one or more user interfaces of a vehicle based upon the identity of the driver. which leads to improved safety.

The present systems and methods are further advantageous over conventional techniques the embodiments herein are not confined to a single type of vehicle and/or situation but may instead allow for versatile operation within multiple different types of vehicles, including ground craft, watercraft, aircraft, and spacecraft. Accordingly, these novel techniques are of particular value to vehicle manufacturers who desire to have these methods and systems available for the users of their vehicles.

Exemplary embodiments of systems and methods for dynamic machine user interfaces are described above in detail. The systems and methods of this disclosure though, are not limited to only the specific embodiments described herein, but rather, the components and/or steps of their implementation may be utilized independently and separately from other components and/or steps described herein.

Although specific features of various embodiments may be shown in some drawings and not in others, this is for convenience only. In accordance with the principles of the systems and methods described herein, any feature of a drawing may be referenced or claimed in combination with any feature of any other drawing.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a programmable logic unit (PLU), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A vehicle comprising:
a plurality of sensors; and
a vehicle controller, wherein the vehicle controller is programmed to:
identify a current driver of the vehicle based upon information from the plurality of sensors;
access a driver profile for the current driver;
determine a vehicle familiarity level of the current driver based upon the driver profile; and
present one or more items on a user interface based upon the driver's vehicle familiarity level.

2. The vehicle of claim 1, wherein the vehicle controller is further programmed to:
receive a plurality of sensor information from the plurality of sensors;
monitor a plurality of actions of the current driver via the plurality of sensor information; and
update the driver profile for the current driver based upon the plurality of actions of the current driver.

3. The vehicle of claim 1, wherein the vehicle controller is further programmed to:
determine that the current driver is at a beginner level of the vehicle familiarity level for the vehicle; and
present the current driver with one or more beginner tooltips about one or more features of the vehicle.

4. The vehicle of claim 1, wherein the vehicle controller is further programmed to:
determine that the current driver is at an intermediate level of the vehicle familiarity level for the vehicle; and
present the current driver with one or more intermediate tooltips about one or more features of the vehicle.

5. The vehicle of claim 1, wherein the vehicle controller is further programmed to:
determine that the current driver is at an experienced level of the vehicle familiarity level for the vehicle; and
prevent the current driver from receiving one or more tooltips about one or more features of the vehicle.

6. The vehicle of claim 1, wherein the vehicle controller is further programmed to:
determine a feature experience level for the current driver for a first feature of the vehicle; and
determine whether or not to present a tooltip for the first feature based upon the feature experience level of the current driver.

7. The vehicle of claim 1, wherein the vehicle controller is further programmed to determine whether or not to present a tooltip for a first feature based upon whether or not the tooltip for the first feature has been presented to the current driver.

8. The vehicle of claim 1, wherein the vehicle controller is further programmed to determine an app or subscription to present to the current driver based upon the driver profile of the current driver.

9. The vehicle of claim 8, wherein the vehicle controller is further programmed to determine the app or subscription to present to the current driver based upon one or more apps that the current driver owns.

10. The vehicle of claim 1, wherein the vehicle controller is further programmed to change one or more settings of the vehicle based upon the driver profile.

11. The vehicle of claim 1, wherein the vehicle controller is further programmed to store the driver profile in an external database.

12. The vehicle of claim 1, wherein the vehicle controller is further programmed to retrieve the driver profile for the current driver from an external database.

13. A computer device comprising:
at least one memory; and
at least one processor in communication with the at least one memory, the at least one processor programmed to:
identify a current driver of a vehicle based upon information from a plurality of sensors;
access a driver profile for the current driver;
determine a vehicle familiarity level of the current driver based upon the driver profile; and
present one or more items on a user interface based upon the driver's vehicle familiarity level.

14. The computer device of claim 13, wherein the at least one processor is further programmed to:
receive a plurality of sensor information from the plurality of sensors;
monitor a plurality of actions of the current driver via the plurality of sensor information; and
update the driver profile for the current driver based upon the plurality of actions of the current driver.

15. The computer device of claim 13, wherein the at least one processor is further programmed to:
determine that the current driver is at a beginner level of the vehicle familiarity level for the vehicle; and
present the current driver with one or more beginner tooltips about one or more features of the vehicle.

16. The computer device of claim 13, wherein the at least one processor is further programmed to:
determine that the current driver is at an intermediate level of the vehicle familiarity level for the vehicle; and
present the current driver with one or more intermediate tooltips about one or more features of the vehicle.

17. The computer device of claim 13, wherein the at least one processor is further programmed to:
determine that the current driver is at an experienced level of the vehicle familiarity level for the vehicle; and
prevent the current driver from receiving one or more tooltips about one or more features of the vehicle.

18. The computer device of claim 13, wherein the at least one processor is further programmed to:
determine a feature experience level for the current driver for a first feature of the vehicle; and
determine whether or not to present a tooltip for the first feature based upon the feature experience level of the current driver.

19. The computer device of claim 13, wherein the at least one processor is further programmed to determine whether or not to present a tooltip for a first feature based upon whether or not the tooltip for the first feature has been presented to the current driver.

20. A method for controlling a vehicle, the method implemented by a vehicle controller associated with the vehicle comprising at least one processor in communication with at least one memory, the method comprising:
identifying a current driver of a vehicle based upon information from a plurality of sensors;
accessing a driver profile for the current driver;
determining a vehicle familiarity level of the current driver based upon the driver profile; and
presenting one or more items on a user interface based upon the driver's vehicle familiarity level.
